(19) United States
(12) Patent Application Publication
(10) Pub. No.: US 2002/0015991 A1
(43) Pub. Date: Feb. 7, 2002

(54) BIOREMEDIATION OF HALOGENATED HYDROCARBONS BY INOCULATION WITH A DEHALOGENATING MICROBIAL CONSORTIUM

(76) Inventors: MICHAEL JARLATH BRENNAN, BURNT HILLS, NY (US); KIM ALDEN DEWEERD, VALATIE, NY (US); KEVIN PATRICK FLANAGAN, REXFORD, NY (US); MARK ROBERT HARKNESS, TROY, NY (US); JAMES LAWRENCE SPIVACK, COBLESKILL, NY (US)

Correspondence Address: GENERAL ELECTRIC COMPANY, CRD PATENT DOCKET ROOM 4A59, P O BOX 8 BUILDING K-1 SALAMONE, SCHENECTADY, NY, 12301

(21) Appl. No.: 09/451,382

(22) Filed: Nov. 30, 1999

(51) Int. Cl. B09B 3/00; C07F 1/00; C10G 32/00

(52) U.S. Cl. 435/262.5; 435/262; 435/281

(57) ABSTRACT

A method for the remediation of a site contaminated with at least one halogenated hydrocarbon, comprising inoculating the site with a microbial consortium which comprises microbes which under anaerobic conditions collectively dehalogenated the at least one halogenated hydrocarbon to one or more non-halogenated compounds. Suitable microbial consortia may be obtained by laboratory culturing of naturally-occurring soil microbes in the presence of a halogenated hydrocarbon.

### STATEMENT REGARDING FEDERALLY SPONSORED RESEARCH OR DEVELOPMENT

The U.S. Government may have certain rights in this invention pursuant to contract number DE-AC04-94AL85000 awarded by the Department of Energy (DOE).

### BACKGROUND OF THE INVENTION

The present invention relates to methods for the remediation of soil and water, in particular soil and groundwater which have been contaminated with halogenated hydrocarbons.

A number of halogenated hydrocarbons are known to contaminate the soil and/or groundwater at hundreds of sites throughout the U.S. and other parts of the world. Chlorinated hydrocarbons are soluble in groundwater and can therefore be transported to drinking water reservoirs where they may pose serious health hazards. In many groundwater aquifers, chlorinated hydrocarbons undergo only limited transformation and must therefore be removed prior to entry into drinking water receptors.

Trichloroethylene (1,1,2-trichloroethene, or TCE), a volatile, chlorinated aliphatic hydrocarbon, is regarded as the most prevalent groundwater contaminant in the U.S., being the most frequently reported contaminant at hazardous waste sites on the National Priority List of the Environmental Protection Agency (EPA). The wide distribution of TCE can be attributed to its excellent solvent and degreasing properties, which made it desirable for many industrial applications. Its use became subject to regulation when it was found to be a suspected carcinogen in mice. TCE is also one of fourteen volatile organic compounds regulated under the Safe Drinking Water Act Amendments of 1986. Methylene chloride (dichloromethane, DCM) is also regulated under the Safe Drinking Water Act Amendments of 1986. DCM has been in widespread use for several decades, primarily as a solvent in metal degreasing, in paint removers, and in the pharmaceutical industry. DCM has been shown to cause lung and liver cancer in mice. Other chlorinated hydrocarbons of concern include perchloroethylene (tetrachloroethylene, or 1,1,2,2-tetrachlorethene, or PCE) dichlorethylene (1,2-dichloroethene, or DCE) and vinyl chloride (1-chloroethene, or VC).

Conventional methods used to remediate chlorinated hydrocarbons include pump and treat, vacuum extraction, and site excavation. These technologies have high or even prohibitive costs when used to treat large sites. Use of processes which stimulate in situ degradation of contaminants, such as bioremediation (degradation by microbes or other microorganisms) can reduce the substantial expense typically associated with contaminated groundwater cleanup. For example, biodegradation of contaminants by indigenous microbial populations is common, and in many aerobic environments, the addition of nutrients to stimulate the growth of indigenous microorganisms can be an effective bioremediation tool in the cleanup of petroleum hydrocarbons. An alternative approach reported for soils contaminated with petroleum hydrocarbons or certain pesticides is the introduction into the soils of microbes capable of degrading the petroleum hydrocarbons or pesticides. These processes rely on oxidative degradation under aerobic conditions, and the microbes use the contaminant itself as a carbon and energy source.

Anaerobic approaches to in situ bioremediation are generally thought to be less expensive and less invasive than aerobic approaches, largely due to the high cost and engineering challenge associated with the subsurface delivery of oxygen. In anaerobic environments, chlorinated solvents may be bioremediated in a process of sequential chloride removal called reductive dechlorination. In this process, the microorganisms use the chlorinated solvent as an electron acceptor, while using either a reduced carbon compound or hydrogen as an electron donor. Certain microorganisms are known to catalyze the transformation of TCE to ethene, for example, as follows:

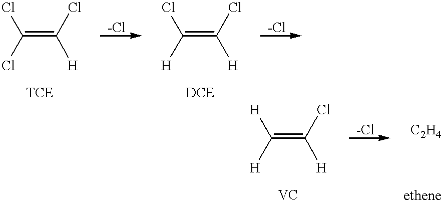

There have also been several reports of transformation of DCM to methane under anaerobic conditions. In order for reductive dechlorination to occur at a site, the site must also have the appropriate pH and temperature, a suitably low oxygen concentration, the appropriate redox conditions (anaerobicity), a steady supply of organic carbon (whether supplemented or naturally available), and the presence of microorganisms capable of reductive dechlorination.

In situ bioremediation using indigenous bacteria under anaerobic conditions is disclosed in U.S. Pat. No. 5,277,815 to Beeman et al., and U.S. Pat. No. 5,578,210 to Klecka et al., both assigned to E. I. duPont de Nemours & Co., Inc. These methods are directed to the bioremediation of sites where the dechlorinating bacteria are present, but the proper environmental conditions for reductive dechlorination do not exist. They require supplementation with various nutrients, and U.S. Pat. No. 5,277,815 in particular requires the successive stimulation of several different types of microorganisms, and results in the biodegradation of PCE and TCE to dihalogenated organic compounds. The groundwater conditions must then be altered to create an anaerobic methanogenic environment to permit further biodegradation of dihalogenated compounds without the accumulation of vinyl chloride. Finally, oxygen is added to the contaminated groundwater to stimulate aerobic biodegradation of the remaining organic contaminants to carbon dioxide and water. A major drawback of this method is that the appropriate dechlorinating microorganisms are not present at all sites in need of remediation. There accordingly remains a need in the art for inexpensive, simplified methods for the in situ bioremediation of chlorinated hydrocarbons from contaminated soil and groundwater.

### SUMMARY OF THE INVENTION

The above-described drawbacks and disadvantages are remedied by the present method, for the remediation of a site contaminated with at least one halogenated hydrocarbon, comprising inoculating the site with a microbial consortium, wherein the microbial consortium comprises microbes which under anaerobic conditions collectively dehalogenate the at least one halogenated hydrocarbon to one or more non- halogenated compounds. Suitable microbial consortia may be obtained by laboratory culturing of naturally-occurring soil microbes in the presence of an added halogenated hydrocarbon, preferably TCE, DCE, VC, DCM, or a combination thereof.

### BRIEF DESCRIPTION OF THE DRAWINGS

FIG. 1 is a graph showing TCE removal from soil inoculated with a microbial consortium of the present invention, and supplemented with either complex nutrients, or a mixture of benzoate and sulfate, or methanol.

FIG. 2 is a graph showing TCE dechlorination products in inoculated samples supplemented with complex nutrients and with methanol.

FIG. 3 is a graph showing DCM removal from soil inoculated with actively dechlorinating column material and amended with either complex nutrients, or benzoate and sulfate, or methanol.

FIG. 4 is a graph showing removal of TCE (initial concentration=13 ppm), cDCE, VC, and DCM in inoculated soil supplemented with complex nutrients. At 42 days, TCE was added to a concentration of 26 ppm and methylene chloride was added to a concentration of 25 ppm.

FIG. 5 is a graph illustrating levels of TCE, cDCE, VC, ethane, and ethene at T=0, in contaminated soil from Strother, Kansas, inoculated with the Pinellas consortium, and in soil from Strother, Kansas, site without inoculation.

FIG. 6 is a graph showing dechlorination of TCE to cDCE in a column containing Dover soil after inoculation with a microbial consortium developed from Pinellas soil, capable of dechlorinating TCE.

### DETAILED DESCRIPTION OF THE PREFERRED EMBODIMENTS

A site contaminated with at least one halogenated hydrocarbon may be remediated by bioaugmentation of the site with a microbial consortium, wherein the microbial consortium comprises microbes which collectively dehalogenate the at least one halogenated hydrocarbon to one or more non-chlorinated compounds. In one embodiment, the consortium comprises microbes which collectively dechlorinate TCE, DCE, and VC to ethene, and which further transform DCM to methane. This method is particularly advantageous for the treatment of contaminated sites where suitable indigenous microbial populations are either not present, or are present at concentrations ineffective for the remediation of halogenated hydrocarbon contaminants. Thus, while prior art methods for decontamination of halogenated hydrocarbons require the presence of an indigenous population of microbes capable of decontaminating the site, the present method of bioaugmentation has no such constraints.

The halogenated hydrocarbons are preferably volatile, chlorinated hydrocarbons, for example those commonly used as solvents. These include but are not limited to 1,1,2,2-tetrachloroethene (perchloroethylene, or PCE), 1,1,2-trichlorethene (TCE), 1,1,2-trichlorethane (TCA), 1,2-cis-dichloroethene (c-DCE), 1,2-trans dichloroethene, 1,1-dichloroethene, 1-chloroethene (vinyl chloride, or VC), 1-chloroethane, carbon tetrachloride, trichloromethane (chloroform), dichloromethane (DCM, or methylene chloride), and chloromethane (methyl chloride). Higher chlorinated homologs, e.g., chlorinated propane, chlorinated propene, and the like may also be remediated. Remediation of other halogenated hydrocarbons is also within the scope of the present invention, including fluorinated, brominated, and iodinated hydrocarbons.

While a suitable microbial consortium may be obtained from any source, in a preferred embodiment the microbial consortium is obtained by laboratory culturing of the indigenous microbes present at a site contaminated with at least one chlorinated hydrocarbon. Culturing is by using methods known by those of ordinary skill in the art. For example, microcosm bottles, reactors, or columns comprising aquifer material from the contaminated site are prepared, and groundwater from the site amended with various nutrients is added or pumped through the soil matrix. If necessary, the groundwater is supplemented with at least one chlorinated hydrocarbon, for example TCE. The microcosms, reactors, or columns are maintained and fed until microbial dehalogenation of TCE to ethene or ethane is observed.

Using this procedure, microbial consortia for dechlorination were produced by preparing soil columns from aquifer material and groundwater from a TCE-contaminated site in Largo, Fla. (the Pinellas site). Columns (60 cm×2.5 cm diameter) were filled with approximately 265 g of soil, and groundwater, supplemented with TCE to a concentration of 20 mg/L, was pumped through the soil matrix at a rate of 3-5 mL/min. Revised anaerobic mineral media (RAMM) (as disclosed by D. R. Shelton and J. M. Tiedje, in Appl. Environ. Microbiol. 1984, 47:850-857, which is incorporated by reference herein) and other nutrients were also added to the circulating groundwater to a final concentration as follows: column 1—methanol (10 mM); column 2—a mixture of methanol (10 mM), lactate (5 mM), sulfate (10 mM) and complex nutrients consisting of 0.1% casamino acids; and column 3—a mixture of benzoate (3 mM) and sulfate (1.25 mM). The experiments were run at room temperature (20-25° C.).

Microbial dehalogenation of TCE to c-DCE was observed after 83-89 days in column 2 (complex nutrients), 104-112 days in column 3 (benzoate/sulfate), and 129-150 days in column 1 (methanol). TCE was subsequently dehalogenated to VC and ethene in column 2, but stopped at c-DCE in the other two columns. If sulfate was removed, c-DCE was further converted to VC in column 3. (TCE and cDCE were identified and quantitated by gas chromatography (GC) using an electron capture detector (ECD). Alternatively, TCE, DCE, and VC were quantitated using EPA Method 8010. Ethene was identified and quantitated using a purge and trap system, followed by GC analysis using a flame ionization detector (FID).

Prior to in situ inoculation at the site to be remediated, it is advantageous to test bioaugmentation with the microbial consortia in vitro. For example, the above-produced consortia were tested for in vitro dechlorination of TCE by removing a soil sample (5 grams) from each of the soil columns and transferring to triplicate 120 mL serum bottle microcosms prepared with fifty grams of fresh Pinellas soil in each bottle, after which the bottles were filled with groundwater until only four mLs of headspace remained. TCE was added to a concentration of 25 mg/L, and each sample was further supplemented with the corresponding nutrient mixtures used in the production column. The bottles were incubated upright in the dark at room temperature (20-25° C.) and periodically assayed to determine levels of TCE and dehalogenation products.

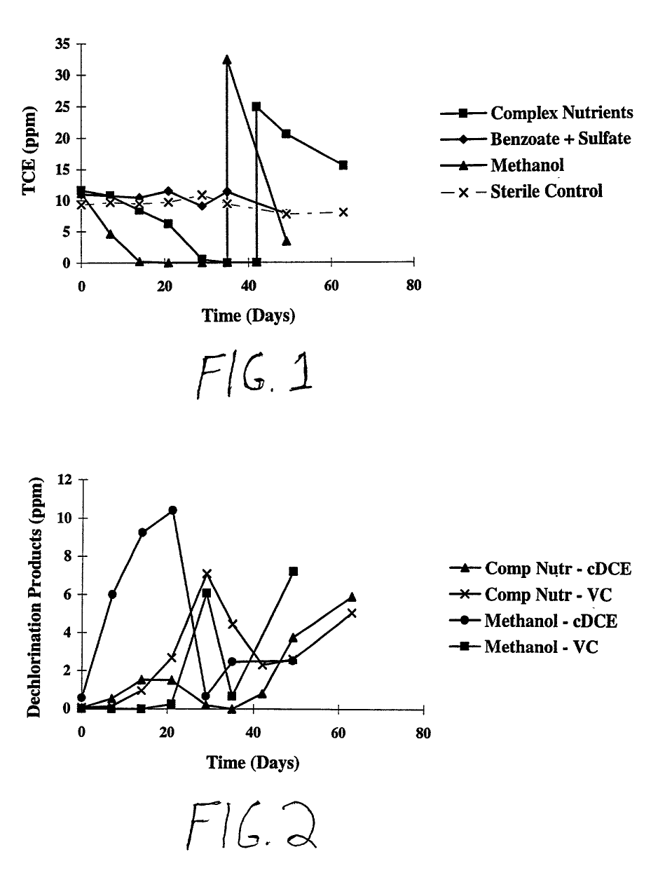

As shown in FIG. 1, dechlorination of TCE in the freshly prepared soil microcosms occurred without a lag time in the samples supplemented with methanol and with the complex nutrient mixture. In this case, it took only 15 days for TCE to be dehalogenated to cis-DCE and VC in the samples supplemented with methanol, and 35 days for the TCE to be dehalogenated to cis-DCE and VC in the samples supplemented with complex nutrients. FIG. 2 shows the evolution of each of these products arising from the bioaugmented soils. Ethene was also identified as a product of the dechlorination of TCE by GC-MS. (data not shown). No dehalogenation of TCE was noted in the benzoate/sulfate microcosms.

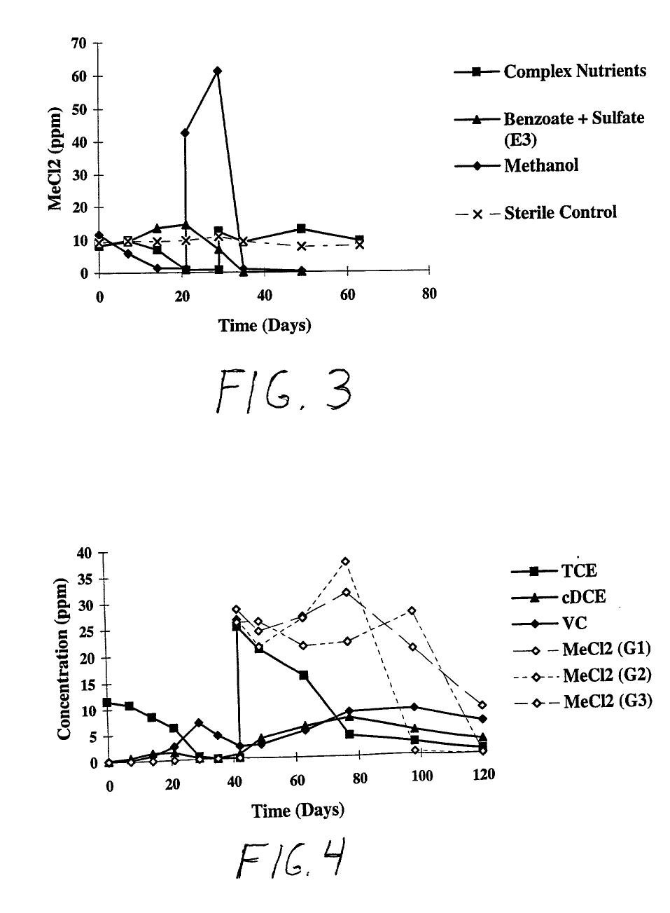

The in vitro studies further show that bioaugmentation with the above-produced consortia can result in remediation of a variety of hydrocarbon contaminants. Using the consortia produced in the presence of added TCE, microcosms were prepared as described above, except that instead of TCE, dichloromethane (DCM) was added to the microcosms at a concentration of 10 mg/L. As shown in FIG. 3, dechlorination of DCM also occurred with no lag time in samples supplemented with methanol or complex nutrients. Alternatively, using the consortium produced in the presence of added TCE and complex nutrients, microcosms were prepared as above, wherein TCE was initially added to a concentration of 13 mg/L and DCM was added to a concentration of 10 mg/mL. At 42 days, TCE and DCM were added again to concentrations of 26 mg/L and 25 mg/L, respectively. As shown in FIG. 4, TCE was preferentially dechlorinated, followed by DCM degradation after the TCE concentration was substantially lowered. (Because DCM concentrations between replicates varied so widely, each replicate is plotted separately in FIG. 4.)

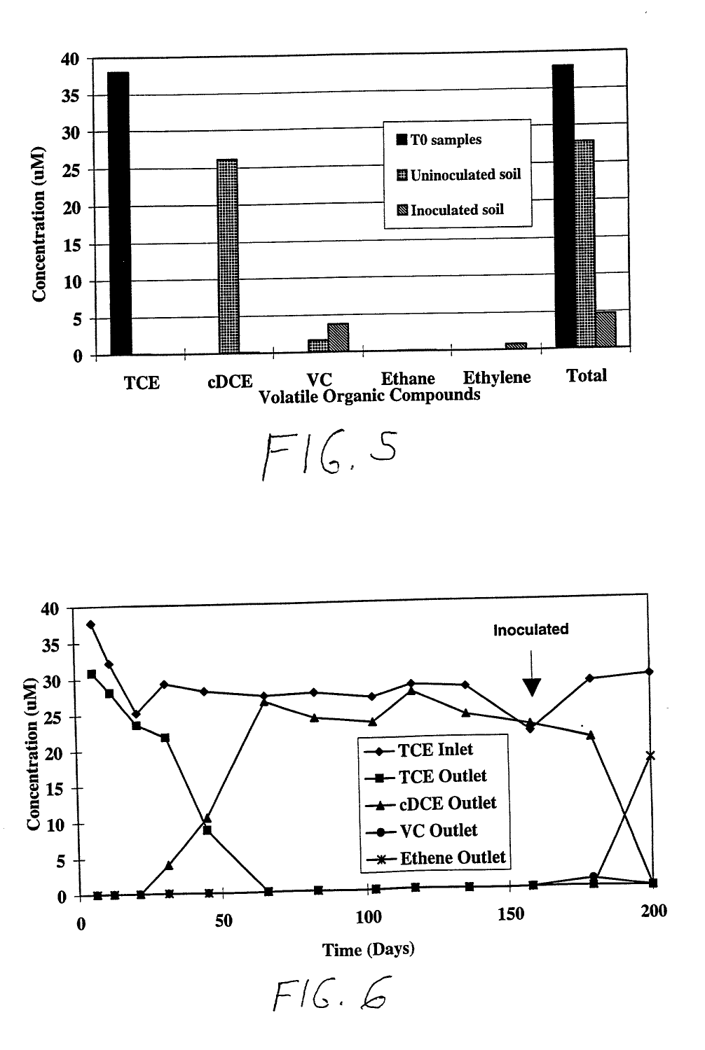

Bioaugmentation using the above-produced consortia was also effective to remediate contaminated samples from sites other than those used to produce the consortia. For example, a soil sample (5 g) comprising the above-produced microbial consortium obtained from Pinellas soil (supplemented with RAMM, methanol, and lactate) was used to inoculate a microcosm bottle containing 50 grams of fresh soil material from a TCE-contaminated site at Strother Field, Kansas. Levels of TCE, cDCE, VC, ethane, and ethene in the Strother Field sample were determined at the time of inoculation and after 45 days of incubation in both the inoculated and in the indigenous, uninoculated soil. The soil containing the Pinellas inoculum was dechlorinated to a much greater extent than the uninoculated soil material (FIG. 5). In addition, dechlorination using the consortium occurred faster than dechlorination in the presence of the native bacteria alone.

Similarly, soil from a TCE-contaminated site at Dover Air Force Base, Delaware, was packed into a glass column (60 cm×5.0 cm diameter). Groundwater from the same site, supplemented with TCE (5 mg/L), sodium lactate(2.5 mM), methanol (5.0 mM), ammonium chloride (35 mg/L), trimetaphosphate (10 mg/L), yeast extract (10 mg/L), and sodium bromide (0.6 mM) was pumped through the column at a rate of 0.1 mL/min. Levels of TCE were periodically assayed at the inlet and outlet of the column. As shown in FIG. 6, the inlet concentration of TCE remained essentially constant over 200 days. After approximately thirty days, the level of TCE at the outlet was observed to decrease and the level of cDCE was observed to increase, indicating the dechlorination of TCE to cDCE. No other dechlorination products were identified. The column was monitored for another ninety days, and the dechlorination of TCE to cDCE was still observed, but there was no evidence of cDCE dechlorination. The column was then inoculated with 5% by volume of a soil slurry comprising the Pinellas dechlorinating consortium produced in the presence of RAMM, methanol, and sodium lactate. The concentration of cDCE at the outlet decreased to nondetectable levels by about twenty days after inoculation, which was followed by the production of ethylene with a transient increase in VC. These observations were confirmed in parallel bottle studies using fresh Dover soil, wherein complete dechlorination of TCE to ethylene was observed in bottles amended with sodium lactate (5 mM) and methanol (10 mM) and TCE (5 mg/L).

Once a suitable microbial consortium has been produced, the soil, sediments, and/or water of a contaminated site is remediated by augmentation with the consortium. Augmentation is generally by inoculation of the site with the consortium by methods known by those of ordinary skill in the art, for example through the use of injection wells or other forms of conduits. Since the consortia function anaerobically, augmentation preferably occurs in an anearobic zone of the contaminated site. Anaerobicity may be detected, for example, by measurement of a low dissolved oxygen and a negative oxidation-reduction potential in water from the zone, as disclosed by E. J. Bouwer in “Handbook of Remediation”, Norris, R. D., Hinchee, R. E., Brown, R., McCarty, P. L., Semprini, L., Wilson, J. T., Kampbell, D. H., Reinhard, M., Bouwer, E. J., Borden, R. C., Vogel, T. M., Thomas, J. M., Ward, C. H. (Eds.), Lewis Publishers, 1994, pp. 149-175, which is incorporated by reference herein.

The amount of microbes used should be an amount effective to result in dechlorination of the contaminants to the desired level. The amounts will therefore vary and may be readily determined by one of ordinary skill in the art, depending on the efficacy of the consortium and the level of decontamination required. The quantity of microbes and the efficacy of the consortium may also be affected by adjusting or maintaining at least one site parameter. Exemplary parameters include, but are not limited to, pH, electron donor or nutrient level, oxygen level, rate of flow of the aquifer, and level of toxic or inhibitory compounds. Adjustment is by means known in the art, for example, electron donors such as organic acids, sugars, alcohols, or other suitable carbon-containing substrates and other nutrients may be injected or otherwise added to the subsurface to stimulate bacterial activity and cause the aquifer to become anaerobic. Anaerobicity may be increased or maintained by pumping nitrogen or other inert gases to the zone of remediation.

Bioaugmentation is particularly advantageous for the treatment of contaminated sites where suitable indigenous microbial populations are either not present, or are present at concentrations ineffective for the remediation of chlorinated hydrocarbon contaminants, for example, in contaminated aquifers. There are a number of reasons why a site may be unable to support the appropriate microbial growth; for example, the site may have been exposed to the contaminant for an insufficient time to allow adaptation and growth, or may be insufficiently anaerobic. This method is also particularly advantageous where the speed of decontamination is a consideration. Adding a microbial population with known biodegradative capabilities can be used to start the remediation process with little or no lag time. It is also advantageous where little is known about the site other than the original source of contamination, and little money is available for testing. Inoculation with an appropriate microbial consortium assures that the proper microbes are present in sufficient numbers to destroy the contaminant.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A method for the anaerobic bioremediation of a site contaminated with at least one halogenated hydrocarbon, comprising bioaugmenting the site with a microbial consortium capable of transforming the at least one halogenated hydrocarbon to at least one non-halogenated hydrocarbon, in a quantity effective to remediate the at least one halogenated hydrocarbon.

2. The method of claim 1, wherein the at least one halogenated hydrocarbon is selected from the group consisting of volatile chlorinated hydrocarbons.

3. The method of claim 2, wherein the at least one halogenated hydrocarbon is selected from the group consisting of 1,1,2,2-tetrachloroethene, 1,1,2-trichlorethene, 1,1,2-trichlorethane, 1,2-cis-dichloroethene, 1,2-trans dichloroethene, 1,1-dichloroethene, 1-chloroethene, 1-chloroethane, carbon tetrachloride, trichloromethane, dichloromethane, and chloromethane.

4. The method of claim 2, wherein the at least one halogenated hydrocarbon is selected from the group consisting of 1,1,2-trichlorethene, 1,2-cis-dichloroethene, 1-chloroethene, and dichloromethane.

5. The method of claim 1, further comprising adjusting or maintaining at least one parameter of the site to effect remediation.

6. The method of claim 5, wherein the at least one parameter is selected from the group consisting of pH, nutrient level, electron donor level, oxygen level, and rate of flow of the aquifer.

7. The method of claim 6, wherein the at least one parameter is oxygen level.

8. A method for the anaerobic bioremediation of a site contaminated with at least one halogenated hydrocarbon, comprising producing a microbial consortium capable of transforming the at least one halogenated hydrocarbon to at least one non-halogenated hydrocarbon; and bioaugmenting the site with the microbial consortium in a quantity effective to remediate the at least one halogenated hydrocarbon.

9. The method of claim 8, wherein the at least one halogenated hydrocarbon is selected from the group consisting of volatile chlorinated hydrocarbons.

10. The method of claim 8, wherein the at least one halogenated hydrocarbon is selected from the group consisting of 1,1,2,2-tetrachloroethene, 1,1,2-trichlorethene, 1,1,2-trichlorethane, 1,2-cis-dichloroethene, 1,2-trans dichloroethene, 1,1-dichloroethene, 1-chloroethene, 1-chloroethane, carbon tetrachloride, trichloromethane, dichloromethane, and chloromethane.

11. The method of claim 8, wherein the at least one halogenated hydrocarbon is selected from the group consisting of 1,1,2-trichlorethene, 1,2-cis-dichloroethene, 1-chloroethene, and dichloromethane.

12. The method of claim 8, further comprising producing the microbial consortium by culturing the microbes of a soil sample obtained from a site contaminated with at least one halogenated hydrocarbon, wherein the microbes comprise at least one strain capable of transforming at least one halogenated hydrocarbon to at least one non-halogenated hydrocarbon.

13. The method of claim 8, wherein the culturing is in the presence of at least one added halogenated hydrocarbon.

14. The method of claim 13, wherein the at least one added halogenated hydrocarbon is a volatile chlorinated hydrocarbon selected from the group consisting of 1,1,2,2-tetrachloroethene, 1,1,2-trichlorethene, 1,1,2-trichlorethane, 1,2-cis-dichloroethene, 1,2-trans dichloroethene, 1,1-dichloroethene, 1-chloroethene, 1-chloroethane, carbon tetrachloride, trichloromethane, dichloromethane, and chloromethane.

15. The method of claim 13, wherein the at least one added halogenated hydrocarbon is selected from the group consisting of 1,1,2-trichlorethene, 1,2-cis-dichloroethene, 1-chloroethene, and dichloromethane.

16. The method of claim 13, wherein the at least one added halogenated hydrocarbon is 1,1,2-trichlorethene.
